(19) United States
(12) Patent Application Publication
(10) Pub. No.: US 2013/0217340 A1
(43) Pub. Date: Aug. 22, 2013

(54) WIRELESS COMMUNICATION DEVICE, METHOD OF WIRELESS COMMUNICATION AND COMPUTER PROGRAM PRODUCT FOR THE SAME

(71) Applicant: BUFFALO INC., (US)

(72) Inventor: Hiroshi NAKATAKE, Nagoya-shi (JP)

(73) Assignee: BUFFALO INC., Nagoya-shi (JP)

(21) Appl. No.: 13/764,378

(22) Filed: Feb. 11, 2013

(30) Foreign Application Priority Data
Feb. 17, 2012 (JP) 2012-032490

(51) Int. Cl. H04W 24/02

(52) U.S. Cl. CPC H04W 24/02
USPC 455/73

(57) ABSTRACT

A wireless communication device that performs, during wireless communication using a first channel, multiple cycles of a detection operation to detect a predetermined radio wave in a second channel different from the first channel; and sets the second channel as an available channel when a total time of the multiple cycles of the detection operation amounts to at least a first predetermined time and when the predetermined radio wave is not detected during execution of the detection operation.

### CROSS-REFERENCE TO RELATED APPLICATIONS

The present application claims priority to Japanese Patent Application No. 2012-32490 filed on Feb. 17, 2012, the disclosure of which is hereby incorporated by reference in its entirety.

### BACKGROUND

1. Field of the Disclosure

The disclosure relates to a wireless communication device, a method of wireless communication and a computer program product that causes a wireless communication device to make wireless communication.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

With recent improvement of the communication speed and enhancement of the convenience, wireless communication technology has been used widely in various locations, such as in houses, in companies and in schools. Wireless communication devices have been proposed to have various functions, such as broadband router functions, in addition to the functions of an access point.

Accompanied with advance of the wireless communication technology, there has been a greater tendency to expand the available frequency band for the carrier waves of wireless communication. More specifically, the use of 5 GHz frequency band has been approved, in addition to the conventionally used 2.4 GHz frequency band. In Japan, the interior use of the frequency band in the range of 5.25 to 5.35 GHz (channels 52/56/60/64 as W53) was approved in 2005, and both the interior and exterior uses of the frequency band in the range of 5.47 to 5.725 GHz (eleven channels, i.e., channels 100.104/ . . . /140 as W56) in 2007.

The frequency bands such as W53 and W56 have generally been used as the frequency band of various radars including moving radars such as ship radars, aircraft radars and military radars and stationary radars such as weather readers, so that the common use with wireless communication devices may cause radio interference. In order to prevent or reduce the radio interference, wireless communication devices are obliged to have the DFS (Dynamic Frequency Selection) function for deconfliction.

The DFS function performs CAC (Channel Availability Check) that monitors an object channel to be used for one minute before the actual use of the channel and approves the actual use of the object channel after confirmation of no detection of any of various radar signals and ISM (In Service Monitoring) that continuously monitors the radar signal during the use of the channel. When any radar signal is detected at the channel in use, the DFS function performs avoidance operation to stop the use of the channel within ten seconds. This DFS function is the essential function in any of devices, such as access point, that sets a channel to be used for wireless communication.

This DFS function indicates the priority on the radars in such frequency bands. In the event of detection of any of various radar signals, data transmission through the wireless LAN may be interrupted. This is because the channel in use becomes unavailable in response to detection of any of various radar signals in the frequency band of the channel used for the wireless LAN, while a new object channel to be newly used is not allowed to make communication during a period when no radar service in the frequency band of the channel is confirmed (i.e., during CAC). In this case, communication by the wireless LAN is interrupted for approximately one minute, during which CAC is performed, even when there is no radar signal in the frequency band of the new object channel to be newly used.

The European standard EN 301893 approves the operation of off-channel CAC that monitors in advance for one minute the frequency band of a channel that is currently not used for communication. With respect to a channel with no detection of any of various radar signals by this off-channel CAC, the immediate use of the channel is allowed without performing the general CAC within a period of four hours since the execution of the off-channel CAC. Wireless communication using the channel of the frequency band as the monitor object is, however, still not approved for approximately one minute when the off-channel CAC is performed.

In order to solve at least part of the above problem, there is a desire to provide technology that prevents wireless communication from being continuously interrupted for a predetermined time.

### SUMMARY

According to a first aspect, there is provided a wireless communication device that performs, during wireless communication using a first channel, multiple cycles of a detection operation to detect a predetermined radio wave in a second channel different from the first channel; and sets the second channel as an available channel when a total time of the multiple cycles of the detection operation amounts to at least a first predetermined time and when the predetermined radio wave is not detected during execution of the detection operation.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a system configuration according to one embodiment of the disclosure;

FIG. 2 is a block diagram illustrating the internal structure of an access point;

FIG. 3 illustrates the contents of a table;

FIG. 4 is a timing chart showing a process after power-on of the access point;

FIG. 5 is a flowchart showing a processing flow after power-on of the access point;

FIG. 6 is a flowchart showing the details of off-channel CAC process at step S110 and step S130;

FIG. 7 is a flowchart showing the details of CAC process at step S150;

FIG. 8 is a flowchart showing a processing flow (ISM-related process) in the steady state of the access point;

FIG. 9 is a flowchart showing a processing flow (divisional off-channel CAC process) in the steady state of the access point; and

FIG. 10 is a flowchart showing the details of the processing at step S310.

### DESCRIPTION OF THE PREFERRED EMBODIMENTS

Referring now to the drawings, wherein like reference numerals designate identical or corresponding parts throughout the several views.

### A. Embodiment

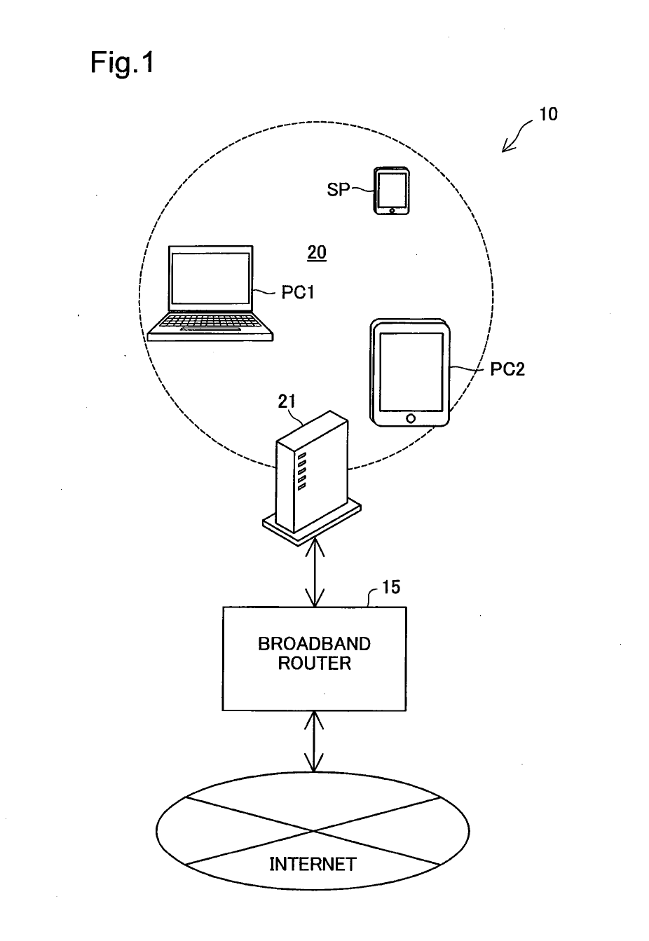

FIG. 1 illustrates a system configuration according to one embodiment of the disclosure. A wireless LAN system 10 includes a broadband router 15 connected to an external network (e.g., Internet) and a wireless LAN access point 21 connected with the broadband router 15 by wire. The access point 21 enables wireless communication with any of a notebook computer PC1, a tablet computer PC2 and a smartphone SP serving as client terminals, and the access point 21, the computers PC1 and PC2 and the smartphone SP constitute a wireless LAN 20.

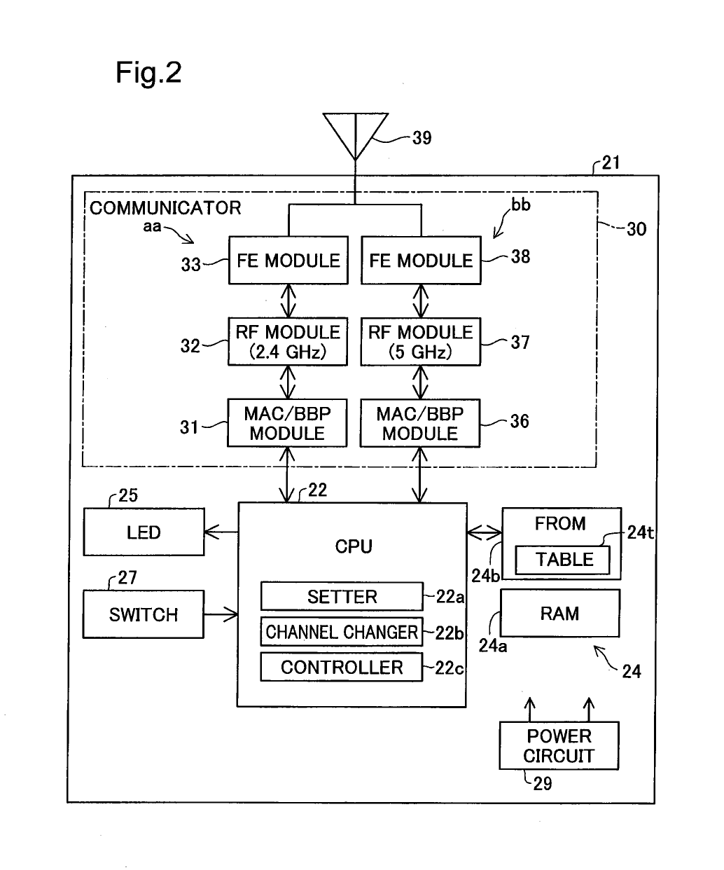

FIG. 2 is a block diagram illustrating the internal structure of the access point 21. The access point 21 includes a CPU 22 that performs overall control of the device, a memory 24 that stores, e.g., a program, an LED 25 that indicates the status of the device, switches 27 that enable various settings, a power circuit 29 that supplies power and a communicator that performs various communication-related processing operations for a wireless LAN.

The CPU 22 loads and executes the program stored in the memory 24 to perform overall control of the access point 21, while executing the program to serve as a setter 22a, a channel changer 22b and a controller 22c. These functions will be described later.

The memory 24 includes a RAM 24 that allows random access and is used to load the program, and a flash ROM (FROM) 24b that stores, for example, the program executed for the operations of the access point 21, default settings and firmware, in a non-volatile or non-transitory manner. The default settings for the operations of the access point 21 include, for example, an SSID and an encryption key used in the wireless LAN 20. A table 24t used for channel setting is stored in the FROM 24b. The contents of the table 24t will be described later.

The communicator 30 has a system aa for communication in 2.4 GHz band and a system bb for communication in 5 GHz band. The communication system aa in 2.4 GHz band and the communication bb in 5 GHz band have substantially the same configurations. Each system includes an MAC/BBP module 31 or 36, an RF module 32 or 37 and an FE module 33 or 37. The FE modules 33 and 38 are connected with a common antenna 39. Although the two communication systems aa and bb are connected with the common antenna 39 according to this embodiment, the FE modules 33 and 38 may be connected individually with separate antennas. The RF module 32 or 37 and the FE module 33 or 38 may be integrated with the MAC/BBP module 31 or 36 and may further be integrated with the CPU 22. The MAC module of the MAC/BBP module 31 or 36 may be implemented by the firmware function of the CPU 22.

The MAC/BBP module 31 or 36 of the communicator 30 is provided as a one-chip element including a media access controller (MAC) module and a baseband processor (BBP) module, wherein the MAC module is located below a data link layer (second layer) and performs transmission and reception in the unit of frames of a predetermined format and error detection. The BBP module is provided as a circuit that performs modulation/demodulation and encoding/decoding of communication signals. The MAC/BBP module 31 or 36 accordingly performs packetization of a communication signal by adding a header, such as a MAC address, to the communication signal, i.e., processing data to communication data.

The RF module 32 or 37, on the other hand, performs up-converting/down-converting of communication signals and noise cancellation. The FE module 33 or 38 serves as a frontend module that is located between the antenna 39 and the RF module 32 or 37 and performs adjustment of receiving sensitivity, adjustment of transmission output and half-duplex signal switching. The respective modules are involved in communication processing of the communication system in the corresponding frequency band, and the communication system bb in 5 GHz band has the function of detecting various radar signals, in addition to ordinary communication processing. The various radars include stationary radars and moving radars, wherein known examples of the stationary radar include weather radars and airport radars, and known examples of the moving radar include military radars, ship radars and aircraft radars.

In the wireless LAN 20, the access point 21 of the above configuration activates the communication system bb in 5 GHz band to establish communication in the infrastructure mode according to the IEEE802.11n or IEEE802.11a standard. When the computers PC1 and PC2 and the smartphone SP as the client terminals have the communication functions only in the 2.4 GHz band, the access point 21 activates the communication system aa in 2.4 GHz band to establish communication in the infrastructure mode according to the IEEE802.11n or IEEE802.11g standard.

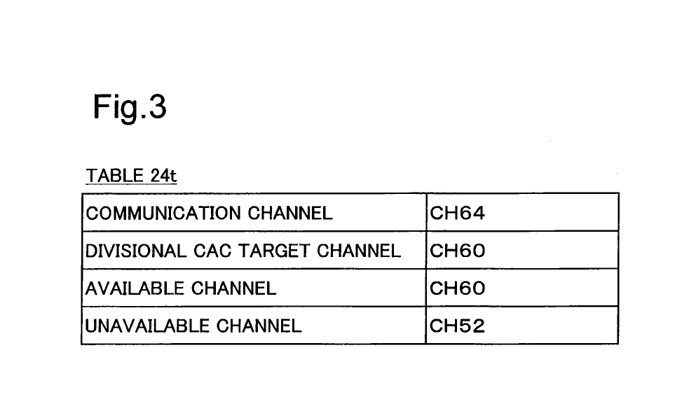

FIG. 3 illustrates the contents of the table 24t. The table 24t sets and stores the following four different channels:
Communication channel
Divisional CAC target channel
Available channel
Unavailable channel

The communication channel is used for actual data communication. The divisional CAC target channel is an object channel that is to be subjected to divisional off-channel CAC described later. The available channel has been subjected to CAC and is specified as an immediately usable channel with no detection of a radar signal during the CAC. The unavailable channel is specified, on the other hand, as a currently unusable channel with detection of a radar signal during the CAC. According to this embodiment, these channels are selected from frequency bands W53 and W56 specified in the 5 GHz band.

In the illustrated example of FIG. 3, CH64 is set as the communication channel, CH60 is set as the divisional CAC target channel and the available channel, and CH 52 is set as the unavailable channel. The following describes the case where the access point 21 activates the communication system bb in 5 GHz band for communication.

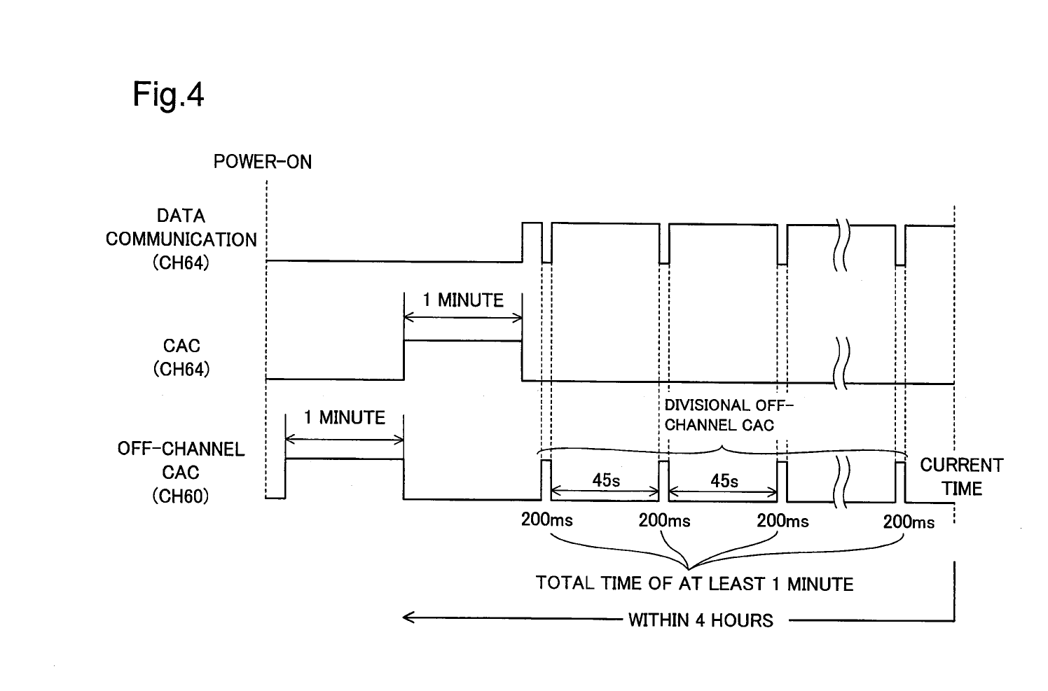

FIG. 4 is a timing chart showing a process after power-on of the access point 21. When the access point 21 is powered on, the communicator 30 (communication system bb) performs off-channel CAC for one minute. As described previously, the off-channel CAC means a detection process of detecting a radar signal at a different channel from the channel set as the communication channel. In the illustrated example of FIG. 4, the communicator 30 (communication system bb) performs the off-channel CAC for one minute with respect to CH60. The first predetermined time in the claims may be, for example, 1 minute.

When no radar signal is detected during the off-channel CAC for one minute, the setter 22a of the CPU 22 sets the channel subjected to the off-channel CAC to the available channel. The period of validity for the available channel is four hours since the start of the off-channel CAC, so that the period of validity for CH60 has expired after elapse of four hours since the start of the off-channel CAC. The second predetermined time in the claims may be, for example, 4 hours.

When the effective available channel is set in the table 24t in the FROM 24b, the communicator 30 (communication system bb) does not perform the off-channel CAC for one minute as described later. The term “effective” herein means that the four-hour period of validity has not yet expired since the start of the off-channel CAC.

On conclusion of the off-channel CAC for one minute, the communicator 30 (communication system bb) performs CAC for one minute with respect to a different channel from the channel subjected to the off-channel CAC. In the illustrated example of FIG. 4, the communicator 30 (communication system bb) performs the CAC with respect to CH 64. When no radar signal is detected during the CAC for one minute, the setter 22a of the CPU 22 sets the channel subjected to the CAC to the communication channel. On conclusion of the CAC for one minute, the communicator 30 (communication system bb) starts data communication using the channel subjected to the CAC, i.e., the channel set as the communication channel. In the illustrated example of FIG. 4, the communicator 30 (communication system bb) starts data communication using CH64.

After starting data communication, the communicator 30 (communication system bb) performs the off-channel CAC in a divided manner for a plurality of periods individually shorter than one minute with respect to a different channel from the channel set as the communication channel between operations of data communication. According to this embodiment, the communicator 30 (communication system bb) performs the off-channel CAC for a length (period) of 200 ms at the intervals of 45 seconds with respect to CH60. The communicator 30 (communication system bb) makes data communication using the channel set as the communication channel (CH64 in this embodiment) during the interval when no off-channel CAC is performed with respect to CH60.

In the description herein, the off-channel CAC for the length less than one minute, such as the off-channel CAC for the length of 200 ms, is called “divisional off-channel CAC” or “divisional CAC”.

When the total time of the execution period of the off-channel CAC (duration time N) is equal to or longer than 1 minute within a time period of four hours before the current time and when no radar signal is detected during the off-channel CAC, the setter 22a of the CPU 22 sets the channel subjected to the off-channel CAC (CH60 in this embodiment) to the available channel.

According to this embodiment, the divisional off-channel CAC for the length of 200 ms is performed 300 hundred times or more before elapse of four hours since the start of the off-channel CAC for one minute performed immediately after power-on, so that the total time of the off-channel CAC amounts to at least one minute. This means satisfaction of a condition that the off-channel CAC for at least one minute is performed within four hours with respect to CH60 even after expiration of the period of validity of the off-channel CAC for one minute performed immediately after power-on. Unless any radar signal is detected during the off-channel CAC, CH60 is accordingly kept as the available channel even after expiration of the period of validity of the off-channel CAC for one minute performed immediately after power-on.

The communicator 30 (communication system bb) performs ISM at the communication channel (CH64 in this embodiment) during data communication. When a radar signal is detected at the communication channel, the channel changer 22b of the CPU 22 changes the communication channel from CH64 to CH60 set as the available channel. This enables the access point 21 to continue data communication.

The controller 22c of the CPU 22 controls the interval of the off-channel CAC for the length of 200 ms. More specifically, the controller 22c of the CPU 22 determines whether any packet having the higher priority than a predetermined level (hereinafter also be called priority packet) in QoS (Quality of Service) control is being processed during data communication and temporarily stops the off-channel CAC when any priority packet is being processed. This gives priority to data communication and thus prevents a delay of data communication.

When it is determined that processing of the priority packet is concluded, the controller 22c of the CPU 22 restarts the off-channel CAC for the length of 200 ms and narrows the interval of the off-channel CAC, in order to complete the off-channel CAC for at least one minute before elapse of four hours since the start of the off-channel CAC for one minute performed immediately after power-on. The following describes a concrete processing flow after power-on of the access point 21.

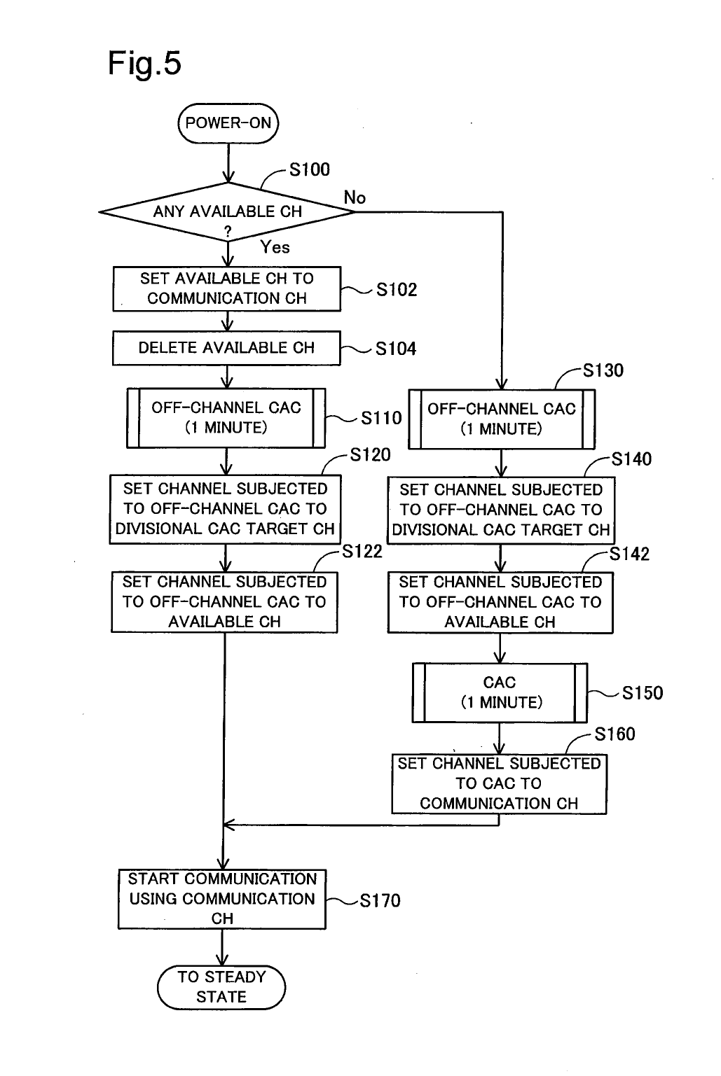

FIG. 5 is a flowchart showing a processing flow after power-on of the access point 21. When the access point 21 is powered on, the setter 22a of the CPU 22 refers to the table 24t in the FROM 24b and determines whether the available channel is set in the table 24t (step S100). When the available channel is set (step S100: Yes), the setter 22a of the CPU 22 sets the channel currently set as the available channel to the communication channel (step S102) and deletes the channel currently set as the available channel (step S104).

At step S110, the communicator 30 (communication system bb) performs off-channel CAC for one minute. The details of the off-channel CAC process will be described later. At step S120, the setter 22a of the CPU 22 sets the channel subjected to the off-channel CAC to the divisional CAC target channel. At step S122, the setter 22a of the CPU 22 sets the channel subjected to the off-channel CAC to the available channel. At step S170, the communicator 30 (communication system bb) starts communication using the channel set as the communication channel. On the start of communication, the access point 21 shifts to the steady state.

When it is determined that no available channel is set (step S100: No), on the other hand, the communicator 30 (communication system bb) performs off-channel CAC for one minute (step S130). The details of the off-channel CAC process at step S130 will be described later. At step S140, the setter 22a of the CPU 22 sets the channel subjected to the off-channel CAC to the divisional CAC target channel. At step S142, the setter 22a of the CPU 22 sets the channel subjected to the off-channel CAC to the available channel.

At step S150, the communicator 30 (communication system bb) performs CAC for one minute. The details of the CAC process will be described later. At step S160, the setter 22a of the CPU 22 sets the channel subjected to the CAC to the communication channel. After setting the communication channel, the processing flow proceeds to step S170 described above, where the communicator 30 (communication system bb) starts communication using the channel set as the communication channel.

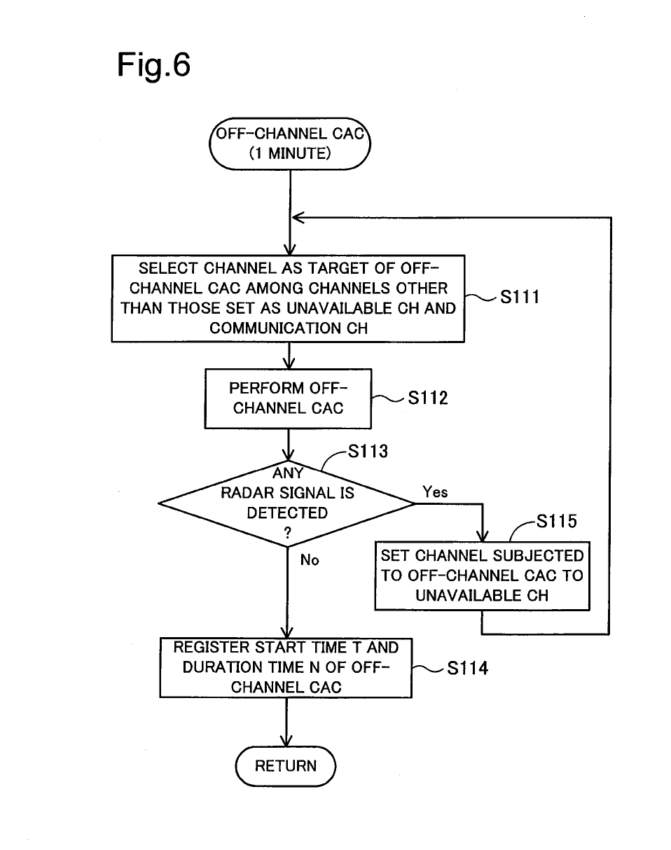

FIG. 6 is a flowchart showing the details of the off-channel CAC process at step S110 and step S130. At step S111, the setter 22a of the CPU 22 refers to the table 24t in the FROM 24b and selects a channel as the target of off-channel CAC among the channels other than those currently set as the unavailable channel and the communication channel. At step S112, the communicator 30 (communication system bb) performs the off-channel CAC for one minute with respect to the channel selected as the target of off-channel CAC.

When no radar signal is detected for one minute, during which the off-channel CAC is performed (step S113: No), the setter 22a of the CPU 22 registers the start time T of the off-channel CAC and the duration time N (one minute in this case) of the off-channel CAC into the FROM 24b at step S114 and shifts the processing flow to the next step shown in FIG. 5 (step S120 or step S140).

When any radar signal is detected during the off-channel CAC (step S113: Yes), on the other hand, the setter 22a of the CPU 22 sets the channel subjected to the off-channel CAC to the unavailable channel at step S115 and returns the processing flow to step S111. The channel set as the unavailable channel is deleted after elapse of a predetermined time to be a candidate selectable as the target of the off-channel CAC.

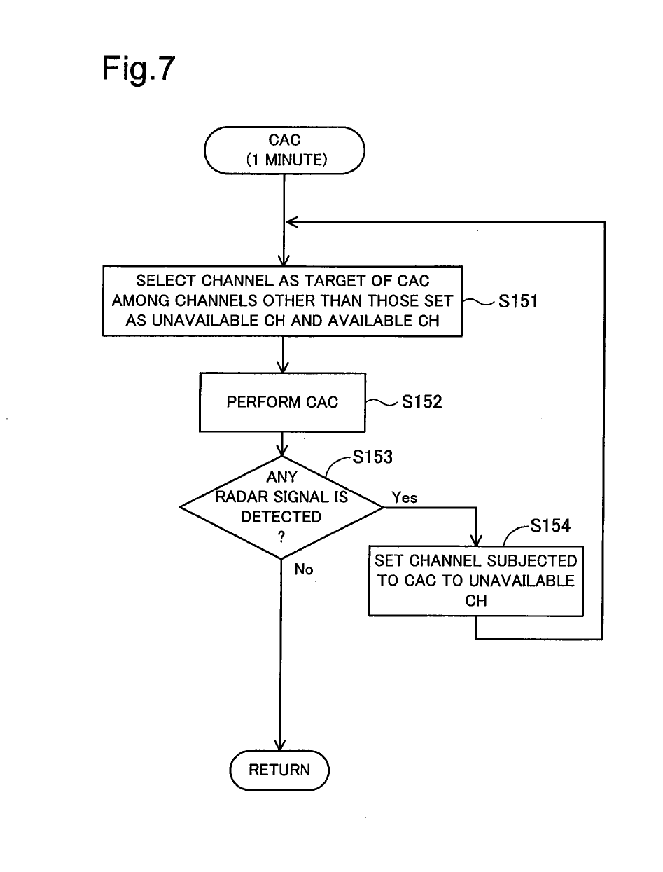

FIG. 7 is a flowchart showing the details of the CAC process at step S150. At step S151, the setter 22a of the CPU 22 refers to the table 24t in the FROM 24b and selects a channel as the target of CAC among the channels other than those currently set as the unavailable channel and the available channel. At step S152, the communicator 30 (communication system bb) performs the CAC for one minute with respect to the channel selected as the target of CAC. When no radar signal is detected during the CAC (step S153: No), the setter 22a of the CPU 22 shifts the processing flow to the next step shown in FIG. 5 (step S160).

When any radar signal is detected during the CAC (step S153: Yes), on the other hand, the setter 22a of the CPU 22 sets the channel subjected to the CAC to the unavailable channel at step S154 and returns the processing flow to step S151.

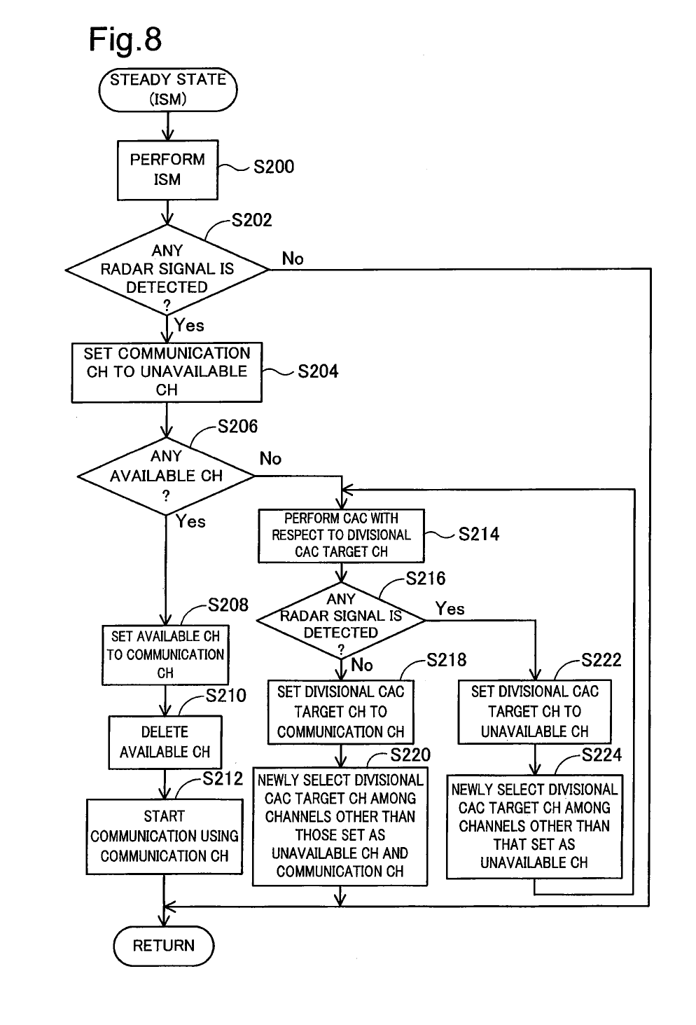

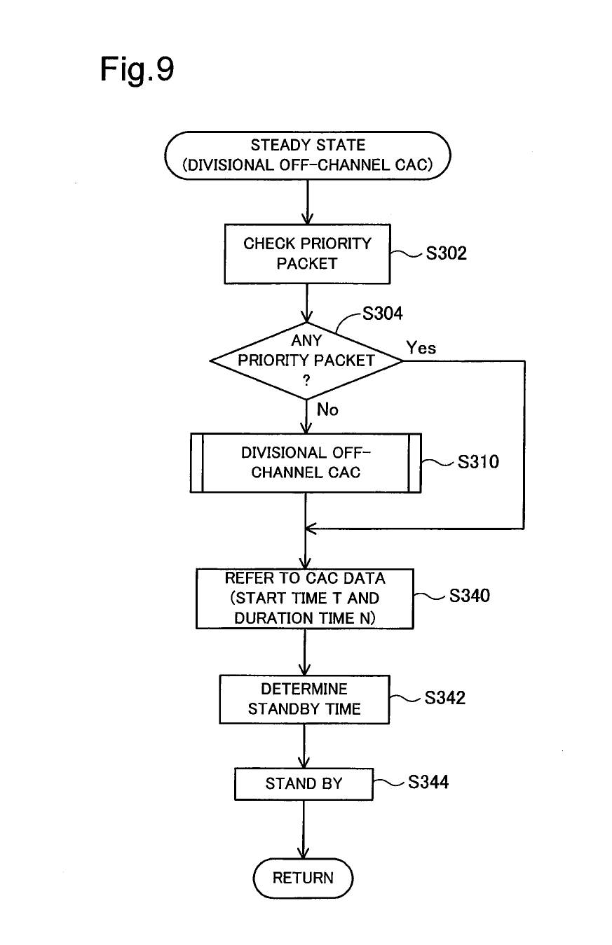

FIGS. 8 and 9 are flowcharts showing processing flows in the steady state of the access point 21. More specifically, FIG. 8 shows a loop regarding ISM process, and FIG. 9 shows a loop regarding divisional off-channel CAC process. The access point 21 repeatedly performs the processing flow of FIG. 8 at predetermined intervals during data communication using the communication channel, while repeatedly performing the processing flow of FIG. 9 at predetermined intervals between the operations of data communication using the communication channel.

The ISM process shown in FIG. 8 is described. At step S200, the communicator 30 (communication system bb) performs ISM. When any radar signal is detected during the ISM (step S202: Yes), the setter 22a of the CPU 22 sets the channel currently set as the communication channel to the unavailable channel (step S204). At step S206, the setter 22a of the CPU 22 refers to the table 24t in the FROM 24b and determines whether there is any channel currently set as the available channel.

When there is any channel currently set as the available channel (step S206: Yes), the setter 22a of the CPU 22 sets the channel currently set as the available channel to the communication channel (step S208). At step S210, the setter 22a of the CPU 22 deletes the channel currently set as the available channel. The communicator 30 (communication system bb) starts communication using the channel set as the communication channel at step S212 and, after elapse of a predetermined time, returns the processing flow to step S200 where the communicator 30 (communication system bb) performs ISM.

When no radar signal is detected (step S202: No), on the other hand, after elapse of a predetermined time, the setter 22a of the CPU 20 returns the processing flow to step S200 where the communicator 30 (communication system bb) performs ISM.

When there is no channel currently set as the available channel (step S206: No), on the other hand, the communicator 30 (communication system bb) performs CAC with respect to the channel set as the divisional CAC target channel (step S214). This CAC continues until the total of the duration time N indicated by CAC data where the start time T is within four hours back from the current time amounts to the length of one minute. The CAC data herein includes, for example, data regarding the start time T and the duration time N of the CAC or the off-channel CAC.

When the communicator 30 (communication system bb) does not detect any radar signal during the CAC of step S214 (step S216: No), the setter 22a of the CPU 22 sets the channel currently set as the divisional CAC target channel to the communication channel (step S218). The setter 22a of the CPU 22 newly selects a divisional CAC target channel among the channels other than those currently set as the unavailable channel and the communication channel at step S220 and, after elapse of a predetermined time, returns the processing flow to step S200.

When the communicator 30 (communication system bb) detects any radar signal (step S216: Yes), on the other hand, the setter 22a of the CPU 22 sets the channel currently set as the divisional CAC target channel to the unavailable channel (step S222). The setter 22a of the CPU 22 newly selects a divisional CAC target channel among the channels other than that currently set as the unavailable channel at step S224 and returns the processing flow to step S214.

The divisional off-channel CAC process shown in FIG. 9 is described. At step S302, the controller 22c of the CPU 22 determines whether any priority packet in QoS control is being processed during data communication using the communication channel. More specifically, the controller 22c of the CPU 22 checks TOS (Type Of Service) included in an IP header of the packet and thereby determines whether any priority packet is being processed.

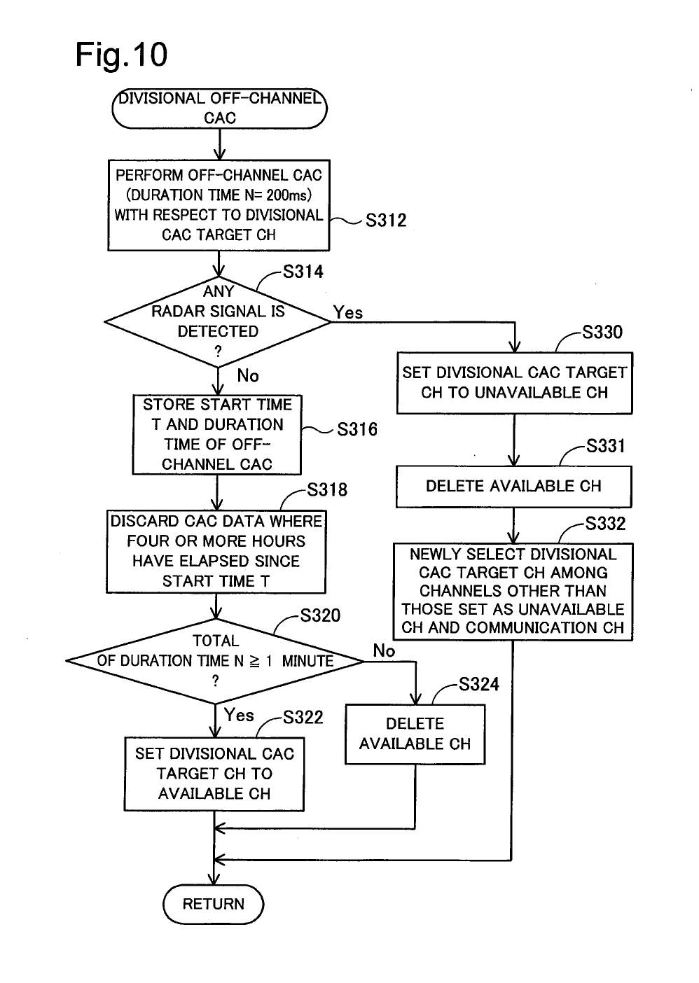

When no priority packet is being processed (step S304: No), the communicator 30 (communication system bb) performs divisional off-channel CAC (step S10) and then shifts the processing flow to step S340. The details of the processing at this step S310 will be described later with reference to FIG. 10. When any priority packet is being processed (step S304: Yes), on the other hand, the communicator 30 (communication system bb) shifts the processing flow to step S340 without performing the divisional off-channel CAC.

At step S340, the controller 22c of the CPU 22 refers to the data regarding the start time T and the duration time N of the off-channel CAC out of the CAC data stored in the FROM 24b. At step S342, the controller 22c of the CPU 22 determines a standby time (i.e., interval of the divisional off-channel CAC), based on the CAC data stored in the FROM 24b.

More specifically, the controller 22c of the CPU 22 determines the interval of the divisional off-channel CAC, in order to cause the total of the duration time N indicated by the CAC data to amount to at least one minute before expiration of the period of validity of the channel set as the available channel. The excessively short interval of the divisional off-channel CAC may, however, lead to the excessively short execution time of data communication, so that the controller 22c of the CPU 22 does not set the interval of the divisional off-channel CAC to be shorter than a predetermined interval. At step S344, the controller 22c of the CPU 22 stands by until elapse of the determined standby time and returns the processing flow to step S302.

FIG. 10 is a flowchart showing the details of the processing at step S310. At step S312, the communicator 30 (communication system bb) performs off-channel CAC with respect to the channel set as the divisional CAC target channel. When no radar signal is detected during the off-channel CAC of step S312 (step S314: No), the controller 22c of the CPU 22 stores the start time T and the duration time N of this off-channel CAC into the FROM 24b (step S316).

At step S318, the controller 22c of the CPU 22 discards the CAC data where four or more hours to the current time have elapsed since the start time T out of the CAC data (start time T and duration time N) stored in the FROM 24b. At step S320, the controller 22c of the CPU 22 determines whether the total of the duration time N indicated by the CAC data stored in the FROM 24b amounts to at least one minute.

When the total of the duration time N indicated by the CAC data amounts to at least one minute (step S320: Yes), the setter 22a of the CPU 22 sets the channel currently set as the divisional CAC target channel to the available channel (step S322) and shifts the processing flow to step S340 of FIG. 9. When the total of the duration time N indicated by the CAC data does not amount to at least one minute (step S320: No), on the other hand, the setter 22a of the CPU 22 deletes the channel currently set as the available channel (step S324) and shifts the processing flow to step S340 of FIG. 9.

When any radar signal is detected during the off-channel CAC of step S312 (step S314: Yes), on the other hand, the setter 22a of the CPU 22 sets the channel currently set as the divisional CAC target channel to the unavailable channel (step S330) and deletes the channel currently set as the available channel (step S331). At step S332, the setter 22a of the CPU 22 newly selects a divisional CAC target channel among the channels other than those currently set as the unavailable channel and the communication channel and shifts the processing flow to step S340 of FIG. 9.

As described above, the procedure of the embodiment performs the off-channel CAC in a divided manner at the intervals between the operations of data communication, i.e., performs the off-channel CAC in the background of data communication, thus enabling conclusion of the off-channel CAC while preventing interruption of data communication continuously for one minute.

### B. Modifications

The disclosure is not limited to the above embodiment but various modifications and variations may be made to the embodiment without departing from the scope of the disclosure. Some examples of possible modifications are given below.

B1. Modification 1

The controller 22c of the CPU 22 controls the interval of the divisional off-channel CAC according to the embodiment, but may alternatively control the length of the execution period (duration time N) of the divisional off-channel CAC. The controller 22c of the CPU 22 may otherwise control both the interval and the length of the execution period of the divisional off-channel CAC. For example, in the case of data communication with the high priority, the controller 22c of the CPU 22 may increase the interval of the divisional off-channel CAC, may decrease the length of the execution period (duration time N) of the divisional off-channel CAC or may increase the interval of the divisional off-channel CAC with decreasing the length of the execution period (duration time N) of the divisional off-channel CAC. In other words, the controller 22c of the CPU 22 may perform control to decrease at least one of the frequency of interruption and the interruption time of active wireless communication associated with the divisional off-channel CAC, so as to reduce or prevent degradation of the quality of active wireless communication.

B2. Modification 2

The controller 22c of the CPU 22 controls the interval of the divisional off-channel CAC based on the presence or the absence of a priority packet according to the embodiment, but may control the interval and the length of the execution period of the divisional off-channel CAC based on the specification of data communication other than the presence or the absence of a priority packet. The specification of data communication other than the presence or the absence of a priority packet may be, for example, the port number and the payload as the actual or body data of the packet, the priority in WMM (Wi-Fi Multimedia) that is QoS control specified for wireless LAN, and the vacant time of CPU.

More specifically, for example, the controller 22c of the CPU 22 may perform control to temporarily set the longer interval of the divisional off-channel CAC during data communication with the high priority in QoS control (for example, transmission of a moving picture) and return the interval of the divisional off-channel CAC to the original length on conclusion of data communication with the high priority. Alternatively the controller 22c of the CPU 22 may perform control to temporarily stop the execution of the divisional off-channel CAC during data communication with the high priority in QoS control (for example, transmission of a moving picture).

According to the above embodiment, the lengths of the individual execution periods of the divisional off-channel CAC are set to a fixed value (200 ms), and the individual intervals of the divisional off-channel CAC are also set to a fixed value (45 s) as shown in FIG. 4. The control of the interval and the length of the execution period of the divisional off-channel CAC may, however, set different values to the lengths of the individual execution periods of the divisional off-channel CAC or may set different values to the individual intervals of the divisional off-channel CAC. In other words, the divisional off-channel CAC may be performed at irregular intervals and for varying execution periods.

B3. Modification 3

The channel set as the target of the divisional off-channel CAC is identical with the channel subjected to the CAC performed immediately after power-on according to the embodiment, but the channel set as the target of the divisional off-channel CAC may be a different channel from the channel subjected to the CAC performed immediately after power-on.

B4. Modification 4

The access point 21 and the broadband router 15 are connected by wire according to the above embodiment, but the access point 21 and the broadband router 15 may be connected by wireless. According to another embodiment, the access point 21 may be integrated with the broadband router 15.

B5. Modification 5

The access point 21 has one communication system in 5 GHz band according to the above embodiment, but may have two or more communication systems in 5 GHz band. For example, the communication system bb of the communicator 30 performs ISM according to the above embodiment, but the access point 21 may separately have a communication system that performs ISM. Additionally, the communication system in 2.4 GHz band of the above embodiment is not essential but may be omitted.

B6. Modification 6

The access point 21 of the above embodiment is designed under the conditions that the period of validity of the off-channel CAC is within 4 hours and that at least one minute is required for the length (duration time) of the off-channel CAC. When these conditions are changed, the conditions for the processing the CAC data (for example, the conditions for the processing of step S318 or step S320 in FIG. 10) may be changed.

B7. Modification 7

The access point 21 performs the off-channel CAC for one minute immediately after power-on according to the above embodiment, but may not perform this off-channel CAC for one minute. According to another embodiment, the access point 21 may monitor the period of validity with respect to the channel set as the available channel and perform the off-channel CAC when the period of validity becomes less than a predetermined time (for example, one hour).

B8. Modification 8

Part of the functions implemented by the software configuration according to the above embodiment may be implemented by the hardware configuration, while part of the functions implemented by the hardware configuration according to the above embodiment may be implemented by the software configuration.

### C. Other Embodiments

According to a first aspect, there is provided a wireless communication device. The wireless communication device includes: circuitry configured to: perform, during wireless communication using a first channel, multiple cycles of a detection operation to detect a predetermined radio wave in a second channel different from the first channel; and set the second channel as an available channel when a total time of the multiple cycles of the detection operation amounts to at least a first predetermined time and when the predetermined radio wave is not detected during execution of the detection operation. This configuration performs the detection operation at the second channel in a divided manner for a plurality of periods individually shorter than the first predetermined time, thus effectively preventing interruption of wireless communication using the first channel continuously for the first predetermined time and setting the second channel subjected to the detection operation to the available channel.

The wireless communication device according to the first aspect, the circuitry may be configured to change a channel used for wireless communication from the first channel to the second channel when the predetermined radio wave is detected in the first channel. When the predetermined radio wave is detected, this configuration makes wireless communication using the second channel set as the available channel.

In the wireless communication device according to the first aspect, the circuitry may be configured to set the second channel as the available channel when execution timings of the multiple cycles of the detection operation are included within a period of a second predetermined time preceding a current time. This configuration satisfies a condition that the detection operation at the second channel is performed within the second predetermined time back from the current time.

The wireless communication device according to the first aspect, the circuitry may be configured to control an interval of the multiple cycles of the detection operation. This configuration controls the timing of completion of the detection operation, thus enabling control of the timing when the second channel is set as the available channel.

The wireless communication device according to the first aspect, the circuitry may be configured to control a length of one cycle time of the detection operation. This configuration controls the timing of completion of the detection operation, thus enabling control of the timing when the second channel is set as the available channel.

In the wireless communication device according to the first aspect, the circuitry may be configured to perform the control based on a condition corresponding to the wireless communication using the first channel. This configuration allows control giving priority to the wireless communication or control giving priority to the detection operation according to the specification of the wireless communication.

In the wireless communication device according to the first aspect, each of the first channel and the second channel may be a channel selected from frequency bands W53 and W56 specified in a 5 GHz band, and the predetermined radio wave may be a radar signal. This configuration ensures observation of the communication standard for W53 (band: 5250 to 5350 MHz) and W56 (band: 5470 to 5725 MHz).

According to a second aspect, there is provided a method performed by a wireless communication device. The method according to the second aspect includes: performing multiple cycles of a detection operation of detecting a predetermined radio wave in a second channel different from a first channel, during wireless communication using the first channel; and setting, by circuitry of the wireless communication device, the second channel as an available channel when a total time of the multiple cycles of the detection operation performed amounts to at least a first predetermined time and when the predetermined radio wave is not detected during execution of the detection operation.

According to a third aspect, there is provided a non-transitory computer-readable medium. The non-transitory computer-readable medium according to the third aspect includes computer program instructions, which when executed by a wireless communication device, cause the wireless communication device to: perform, during wireless communication using a first channel, multiple cycles of a detection operation of detecting a predetermined radio wave in a second channel different from the first channel; and; set the second channel as an available channel when a total time of the multiple cycles of the detection operation performed amounts to at least a first predetermined time and when the predetermined radio wave is not detected during execution of the detection operation.

The second aspect and the third aspect may be implemented as any of various embodiments, like the first aspect described above. The invention may be actualized by any of various other applications, for example, a method and a device of making wireless communication, a wireless communication system, an integrated circuit or a computer program that enables the functions of any of these methods and devices, and a storage medium in which such a computer program is stored.

What is claimed is:

1. A wireless communication device, comprising:
circuitry configured to:
perform, during wireless communication using a first channel, multiple cycles of a detection operation to detect a predetermined radio wave in a second channel different from the first channel; and
set the second channel as an available channel when a total time of the multiple cycles of the detection operation amounts to at least a first predetermined time and when the predetermined radio wave is not detected during execution of the detection operation.

2. The wireless communication device according to claim 1, wherein
the circuitry is configured to change a channel used for wireless communication from the first channel to the second channel when the predetermined radio wave is detected in the first channel.

3. The wireless communication device according to claims 1, wherein
the circuitry is configured to set the second channel as the available channel when execution timings of the multiple cycles of the detection operation are included within a period of a second predetermined time preceding a current time.

4. The wireless communication device according to claim 1, wherein
the circuitry is configured to control an interval of the multiple cycles of the detection operation

5. The wireless communication device according to claim 1, wherein
the circuitry is configured to control a length of one cycle time of the detection operation.

6. The wireless communication device according to claim 4, wherein
the circuitry is configured to perform the control based on a condition corresponding to the wireless communication using the first channel.

7. The wireless communication device according to claim 5, wherein
the circuitry is configured to perform the control based on a condition corresponding to the wireless communication using the first channel.

8. The wireless communication device according to claim 6, wherein
the condition corresponding to the wireless communication corresponds to a priority of communication.

9. The wireless communication device according to claim 7, wherein
the condition corresponding to the wireless communication corresponds to a priority of communication.

10. The wireless communication device according to claim 1, wherein
each of the first channel and the second channel is a channel selected from frequency bands W53 and W56 specified in a 5 GHz band.

11. The wireless communication device according to claim 1, wherein
the predetermined radio wave is a radar signal.

12. A method performed by a wireless communication device, the method comprising:
performing multiple cycles of a detection operation of detecting a predetermined radio wave in a second channel different from a first channel, during wireless communication using the first channel; and
setting, by circuitry of the wireless communication device, the second channel as an available channel when a total time of the multiple cycles of the detection operation performed amounts to at least a first predetermined time and when the predetermined radio wave is not detected during execution of the detection operation.

13. The method according to claim 12, further comprising:
changing a channel used for the wireless communication from the first channel to the second channel when the predetermined radio wave is detected in the first channel.

14. The method according to claim 12, wherein
the setting includes setting the second channel as the available channel when execution timings of the multiple cycles of the detection operation are included within a period of a second predetermined time preceding a current time.

15. The method according to any one of claim 12, further comprising:
controlling at least one of an interval of the multiple cycles of the detection operation and a length of one cycle time of the detection operation.

16. The method according to claim 15, wherein
the controlling is performed based on a condition corresponding to the wireless communication using the first channel.

17. The method according to claim 16, wherein
the condition corresponding to the wireless communication corresponds to a priority of communication.

18. The method according to claim 12, wherein
each of the first channel and the second channel is a channel selected from frequency bands W53 and W56 specified in a 5 GHz band.

19. The method according to claim 12, wherein
the predetermined radio wave is a radar signal.

20. A non-transitory computer-readable medium including computer program instructions, which when executed by a wireless communication device, cause the wireless communication device to:
perform, during wireless communication using a first channel, multiple cycles of a detection operation of detecting a predetermined radio wave in a second channel different from the first channel; and
set the second channel as an available channel when a total time of the multiple cycles of the detection operation performed amounts to at least a first predetermined time and when the predetermined radio wave is not detected during execution of the detection operation.
